(19) United States
(12) Patent Application Publication
(10) Pub. No.: US 2014/0262826 A1
(43) Pub. Date: Sep. 18, 2014

(54) DEVICE AND METHOD FOR PURIFYING FLUIDS USING ELECTROMAGNETIC AND HIGH VOLTAGE ELECTROSTATIC FIELDS

(71) Applicant: HydroDyne Technology, LLC, Los Angeles, CA (US)

(72) Inventors: Shankar Rao, Culver City, CA (US); Michael R. Lombardi, Los Angeles, CA (US); Neil B. Morley, Santa Monica, CA (US)

(73) Assignee: HydroDyne Technology, LLC, Los Angeles, CA (US)

(21) Appl. No.: 14/211,447

(22) Filed: Mar. 14, 2014

Related U.S. Application Data
(60) Provisional application No. 61/782,655, filed on Mar. 14, 2013.

(51) Int. Cl. C02F 1/46

(52) U.S. Cl. CPC C02F 1/46
USPC 205/751; 204/665; 204/664

(57) ABSTRACT

A modularized fluid purification device and a method for fluid purification are provided that utilizes electrical power to create a high voltage electrostatic field through which the fluid is passed in combination with filtration to remove or neutralize both organic and inorganic contaminants. The electrostatic field may be focused using an electromagnetic field, and one or more filters downstream of the electrostatic field may be charged to attract correspondingly charged contaminants. The electrical power for creating the electrostatic field and/or charging the filters may be generated via a power generation module of the device or from an external source of power. Fluid, such as water, that is passed through the device and purified may, as a result, be suitable for human consumption, as well as agricultural and industrial applications.

### CROSS-REFERENCE TO RELATED APPLICATIONS

This application claims the benefit of U.S. Provisional Application No. 61/782,655 entitled “Device and Method for Purifying Fluids Using Electromagnetic and High Voltage Electrostatic Fields,” filed Mar. 14, 2013, the contents of which are incorporated herein in their entirety.

### FIELD OF THE INVENTION

The present invention relates to a novel device and methodology for purifying fluids, such as water.

### BACKGROUND

Only a very small portion of the earth's water is fit for human consumption. That water is known as potable water. It comes primarily from the underground reservoirs. In other instances, water from melting snowcaps and rainfall runoff is collected and then stored in above ground reservoirs or lakes, where it is exposed to atmospheric contamination. Even water in underground reservoirs is susceptible to contamination from percolating waste from a variety of sources.

A substantial portion of the total annual water consumption is used in the husbandry of plants and animals intended for eventual human consumption. It is estimated that at least thirty percent of the electric power consumed within the state of California in the United States is expended moving water for primarily agricultural purposes such as the irrigation of crops and the watering of livestock. Even though water that is suitable for agricultural purposes does not need to meet potable water standards, it must be free of certain contaminates (both organic and inorganic) that might successfully make their way through the food chain so as to present a risk to human or other mammalian wellbeing. The deaths of humans who have eaten fruits and vegetables that had been irrigated with bacterially contaminated water have occurred and been reported as recently as 2012 in the United States.

Another category of water usage involves water that, although not potable or suitable for crop or animal husbandry purposes, might nonetheless be utilized as a tool of industry without presenting inordinate risks of mechanical inefficiency or failure due to the use of contaminated water. There are many contaminants beside bacteria and viruses that can cause problems for the machinery of industry. Water is commonly used for the cooling and heating of machines and structures. Elemental and other contaminants can cause clogging and mechanical inefficiency in tools of industry such as heat exchangers. One very good example of this is the presence of calcium carbonate and bicarbonate in the water in cooling towers of large buildings. The presence of these compounds has long been known to decrease the efficiency of the operation of these machines and to lessen the useful life of them as well.

Accordingly, there is a need for improved systems and methods for purifying water so as to render it potable and fit for human consumption by removing both the organic and inorganic substances that might be contaminating it. Moreover, there is a need for improved systems and methods that provide adequate purification of available water supplies so that water can at least be safely utilized for agricultural endeavors such as crop and animal husbandry, as well as for industrial applications involving machinery and industrial equipment, without inordinate human health risks being presented.

### SUMMARY

Accordingly, it is an object of the present invention to provide a novel device and methodology for the purification of fluids such as water through the use of a modularized system that permits operation even in the absence of an independent source of power if necessary, and which utilizes a combination of magnetic arrays, electrostatic fields and filters to eliminate organic and inorganic contaminants so as to make the fluid consumable by humans and more efficient as a tool of industry. One version of the present invention includes a fully submersible turbine and generator system, which can generate its own power in the presence of a fluid flow.

Accordingly, it is another object of the present invention to provide modular sectioning to permit easy and cost effective replacement of only the modules that need replacement or repair, leaving the balance of the operable modules for continued operation thus minimizing both downtime for the system and cost of operation. Similarly, it is an additional object of the present invention to require utilization of only the particular purification modules required by the particular field of use of the invention.

Accordingly, it is an additional object of the present invention to provide the combination of a fully submersible turbine generator subsystem in combination with individual modules containing: a high voltage transformer; a rectifier; an anode; a cathode; a Halbach magnet array around the outside of the module containing the cathode; a positively charged filtration system; and a negatively charged filtration system to create a self-contained system which can purify water and make it safe for human consumption by removing both organic and inorganic impurities in the presence of simple fluid flow. It is also consistent with the present invention that in situations where there is a readily available supply of electric power so that the turbine-generator is not required, that the turbine-generator module not be included in the system.

It is yet another object of the present invention to provide a novel Halbach style magnetic array that can be placed around the diameter of any size of pipe that carries water or other fluids to provide for easy removal of calcium compounds from the water and thereby provide water or other fluids that can be utilized as a more efficient tool of industry for the cooling of machinery or buildings. It is yet another feature of the present invention to provide a magnetic array wherein the length of the magnets runs parallel to the length of a pipe containing a fluid for purification. It is yet another feature of the present invention to provide the magnets with alternating polarities so as to increase turbulence of the fluid in the pipes.

Another object of the present invention is to provide a standard diameter of the device according to the present invention to simplify manufacturing of devices. According to the present invention, a manifold is provided so that water mains of varying size can be accommodated by placing a number of the devices according to the present invention in parallel by use of the manifold so as to accommodate water mains of any size with a parallel array of devices of a single size in accordance with the present invention thus facilitating standardization of manufacturing and a consequential cost savings.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view of a fully assembled device according to example embodiments of the present invention;

FIG. 2 is a cross-sectional view of the device of FIG. 1 taken along lines 2-2;

FIG. 3 is a perspective view of a portion of the intake housing of the device of FIG. 1 according to example embodiments of the present invention;

FIG. 4 is a sectional view of the intake housing of FIG. 3 taken along lines 3-3;

FIG. 5 is a perspective view of a surge suppressor according to example embodiments of the present invention;

FIG. 6 is a cross sectioned view of the surge suppressor of FIG. 5 taken along lines 6-6 of FIG. 5;

FIG. 7 is a perspective view of the assembled intake housing and surge suppressor according to example embodiments of the present invention;

FIG. 8 is an exploded perspective view of a portion of a device according to example embodiments of the present invention;

FIG. 9 is a cross sectional view of a portion of example embodiments of the present invention taken along lines 9-9 of FIG. 8;

FIG. 10 is a perspective view of an intake and power generation modules of a device according to example embodiments of the present invention;

FIG. 11 is a cross sectional view of the assembled modules of FIG. 10 taken along lines 11-11 of FIG. 10;

FIG. 12 is a perspective view of a portion of the exterior housing of example embodiments of the present invention that are intended for housing an anode, cathode and filtration mechanisms according to example embodiments of the present invention;

FIG. 13 is a cross sectional view of the housing portion taken along lines 13-13 of FIG. 12;

FIG. 14 is a perspective view of staged filters according to example embodiments of the present invention;

FIG. 15 is a cross sectional view of staged filters of FIG. 14 taken along lines 15-15 of FIG. 14;

FIG. 16 is an enlarged view of one of the staged filters of FIG. 15;

FIG. 17 is a perspective view of a Halbach magnet array that is configured to fit over a portion of the exterior housing of the device intended to provide an electromagnetic field to the interior of the device during operation according to example embodiments of the present invention;

FIG. 18 is cross sectional view of the Halbach magnetic array of FIG. 17 taken along lines 18-18 of FIG. 17;

FIG. 19 is a perspective view of an outlet cap according to example embodiments of the present invention;

FIG. 20 is a cross sectional view of the outlet cap of FIG. 19 taken along lines 20-20;

FIG. 21 is an exploded perspective view of an anode-cathode arrangement according to the present invention;

FIG. 22 is a cross sectional exploded view of the anode-cathode arrangement of FIG. 21 taken along lines 22-22 of FIG. 21;

FIG. 23 is a view of the present invention which incorporates a perspective view of the assembly of FIG. 10 with an exploded perspective view an anode cathode, housing, Halbach magnet arrangement, staged filters, and outlet cap according to example embodiments of the present invention; and

FIG. 24 is a cross sectional view taken along lines 24-24 of FIG. 23.

### DETAILED DESCRIPTION

Throughout history there have been many attempts at devising systems for purifying fluids such as water. Traditionally, a source of water is selected for final processing that is already generally free of obvious organic and inorganic contamination. This water is then subjected to steps such as chemical treatment to kill any undetected viral or bacterial contamination. The water is typically treated with chlorine compounds to guarantee the death of any undetected organic contaminants. Additionally, to free the water of any undesirable levels of residual chlorine (after the chlorination process) or other contamination, such as naturally occurring dissolved gases and the other sulfur compounds that sometimes make their way into the water supply trapped underground near sources of fossil fuels, aeration is typically utilized to eliminate the contaminants and the unpleasant smell that often accompanies such contamination. This aeration process is traditionally done at the water treatment plant before delivery of the water to the underground water delivery systems that form the underground labyrinth in most of developed countries.

These steps are, however, undesirable in their own right. Chlorine is itself a chemical contaminant, the full effect of which upon humans is not completely understood despite common usage. The aeration process, although desirable in most instances, often involves costly capital expenditures not readily available in all parts of the world and certainly not available to troops on the move in the field of combat. In addition, these steps are not completely effective in eliminating all forms of contaminants such as heavy and other metals, undesirable inorganic dissolved materials and even infectious organic bacteria and viruses if they are introduced downstream of the water processing facility such as through acts of sabotage or a leaking water main.

There are other forms of technology for dealing with impurities in a gaseous flow, such as those emitted from coal fired power plants. Coal fired power plants emit both highly charged airborne solid free carbon particles and gaseous contaminants such as sulfur dioxide and carbon dioxide. Both categories of contaminants are undesirable. The methods for removing them are varied in type, effectiveness, and commercial practicality.

For the removal of the particulate carbon in such power plant exhaust, “electrostatic precipitators” have been used to pass the hot exhaust gases through electrically biased wire grid systems so as to attract and accumulate highly charged carbon particulates on the wire elements of the grids. Periodically, hammer and anvil systems engage the charged wires so as to dislodge the accumulated particulates in a fashion that causes them to fall into a gutter system, where they are washed away with water to settling ponds.

In the settling ponds, the mixture is permitted to evaporate the water so that the particulates, called “fly ash,” can be removed by heavy equipment and sold to waiting paving companies as an addition to asphalt that is placed upon roads and highways in those areas where asphalt is utilized. Although capital-intensive, the implication of a viable commercial operation makes the effort a little less painful to the bottom lines of the companies with an awareness to build these systems for the sake of the environment.

Similar attempts have been made to eliminate gaseous contaminants such as sulfur dioxide found in the coal fired power plant exhaust. After the removal of the particulates using the electrostatic precipitators, the remaining gases are passed through a water bath so that the carbon dioxide and carbon monoxide molecules can react with the water in a well-known fashion. The sulfur dioxide similarly reacts with the water bath to form sulfuric acid. These systems have not been as well accepted because the concentration of the resultant acids in the bath is not sufficient to render a viable commercial by-product. As a result, the acid by-product of the reaction is considered by some as nothing more than an additional pollutant that needs to be handled in an environmentally friendly fashion.

Various and manifold forms of filtration have been utilized to purify fluids such as water. Both electrically neutral and biased filtration systems have been implemented in the past. However, these systems still generally fail to remove adequate amounts of impurities to make them efficient enough to protect the water supplies of an entire city from the organic and inorganic contamination in a running stream so as to render it safely consumable by humans. The size of most simple or electrically biased filtration systems is not adequate to address the needs of an entire metropolitan area.

Accordingly, embodiments of the present invention are directed to a modularized fluid purification system and a method for fluid purification that utilizes potential self generation of electrical power from the flow of a fluid to be purified, thus permitting the creation of a high voltage electrostatic field through which the fluid is passed in combination with filtration to remove or neutralize both organic and inorganic impurities. In certain modes of operation, electrostatic fields can result in plasma discharge. In some embodiments, the fluid to be purified is water and the process is contemplated as suitable for rendering water appropriate for human consumption. The modular nature of the device is such that it will be easy and inexpensive to manufacture, use, repair and maintain.

With reference to FIGS. 1 and 2, a fluid purification system 10 is shown that includes an intake housing 12 with a venturi 14 to establish a desired level of fluid pressure as fluid travels through the intake housing for presentation downstream. Fluid may be introduced through an inlet 15 under pressure and through the venturi 14 to elevate the level of fluid pressure if needed. The intake housing 12 may include an aperture 16, shown in FIGS. 3 and 4, that is configured to permit mating of the intake housing 12 with a surge suppressor tank 17 to prevent extremely elevated fluid pressure levels that might be detrimental to the balance of the device. The upward neck 18 of the surge tank 17 may be configured to have sufficient length so as to permit excessively pressurized fluid to exit and to maintain the fluid pressure at an optimal level utilizing an air cushion to buffer any excess fluid pressure. The surge tank 17 and its neck 18 are shown in greater detail in FIGS. 5 and 6 and are shown in a mated configuration with the intake housing 12 in FIG. 7.

The intake housing 12 may be mated to a power generation module 20 in a fluid tight manner. This mating may permit properly pressurized fluid to pass from the intake housing 12 to the power generation module 20 so as to drive a turbine 22, which may be rigidly affixed to a shaft 24, as shown in FIGS. 2, 8, and 9. The shaft 24 may have affixed thereto a rotor 26, which rotates with the turbine 22 as fluid drives it interiorly of a series of stators 27 to generate electricity, e.g., acting as a generator. According to embodiments of the present invention, the generator may be made watertight by any suitable means such that it can be immersed within the fluid to be purified. Failure to do so may cause electrical shorting of the generator. The shaft 24 may be carried within a pair of bearings 28, which may be loaded into respective support structures 29. The support structures 29 may, in turn, be configured to engage the interior of the housing of the power generation module 20, as illustrated in FIG. 11, so as to maintain the shaft 24 in a stable, dynamic, and rotatable fashion therewithin. The stator coils 27 may be fixed relative to the housing of the power generation module 20, such as via welding, fasteners, bonding, etc.

As shown in FIGS. 10 and 11, also provided with the power generation module 20 may be a transformer 31 and s rectifier 32, which may be operably interconnected with the stator 27 to provide a high voltage electrical potential that may be used to purify the processed water. With reference to FIGS. 8 and 9, the bearing support structures 29 may include apertures 30 that are configured to permit the passage of the fluid to be purified through the power generation module 20 for further processing after it has been used to generate power. This design may, for example, be used in situations in which water must be purified and there is a pressurized flow of water, but power is not readily available, such as in battlefield environments and in underdeveloped countries. Where power is readily available but there is still a need for water purification, the power generation module 20 may be eliminated from the modularized construction, and the device may use an independent power supply. In some cases, an independent power supply may render the unit 10 more reliable, as such a design requires fewer moving parts that may be prone to failure.

As best seen with closer reference to FIGS. 1, 2, 21, 22, 23 and 24, embodiments of the present invention may be configured to treat the desired fluid by exposing the fluid to a high voltage potential to kill organic contaminants and electrically bias them. Both the organic and any inorganic contaminants contained in the fluid may be more easily filtered from the fluid before the fluid exits the device 10 through the use of electrically biased filtration, as will be more fully described herein below. More specifically, embodiments of the present invention may include a fluid treatment housing 34 configured to house an anode 36 and one or more cathodes 38 associated with the output of the rectifier 32 (or other suitable power source in settings where there is readily available power eliminating the need for the power generation module). The fluid treatment housing 34 (shown in FIGS. 12 and 13) may be configured to create an area between the anode 36 and the cathodes 38 having a high voltage electrostatic field, possibly with induced plasma. This may, in effect, create a kill zone where organic contaminants are destroyed as the fluid that contains such contaminants passes through.

For example, certain types of organic and inorganic contaminants may be attracted to the anode 36 and cathodes 38 as the fluid carrying such contaminants passes through the field, and the contaminants may be deposited upon the anode 36 and cathodes 38. This may result in a periodic need to replace both the anode 36 and the cathodes 38. The fluid treatment housing 34, which may contain the anode 36 and cathodes 38, may be operably connected to the upstream housing (e.g., the power generation module 20 or the intake housing 12 in embodiments in which there is no power generation module 20) in a watertight fashion that permits easy disassembly for replacement of the anode 36 and cathodes 38 when required.

With reference to FIG. 2, a Halbach style magnetic array 40 may be placed circumferentially around the portion of the housing 34, which contains the anode 36 and cathodes 38, to focus the electrostatic field and any induced plasma on the fluid stream for maximum effect. The magnetic array 40 is shown alone in FIGS. 17 and 18. Any suitable rare earth type magnets can be arranged in the array 40 running the length of the section of housing 34 to accomplish this result. The magnetic array 40 may be easily removed from the housing 34 for ease of replacement or to permit easier repair of any components within the housing 34 when required. The magnetic array 40 may be generally fixed relative to the housing 34.

The Halbach array may be sized to permit it to be snuggly fit over the top of the housing 34 to fix it relative to the anode 36 and cathodes 38. Simple mechanical stops can be built into the exterior surface of the housing 34 to assure proper alignment of the various elements. Referring to FIGS. 21 and 22, the anode 36 may be designed to attach to a bearing support structure 29 and may be hollowed to permit the fluid to enter it internally as the treated fluid passes through the apertures 30 of the support structures. As best seen with reference to FIGS. 21 and 22, the anode 36 may be provided with apertures 41 that are configured to permit the fluid to exit from the interior of the anode 36 and to travel into the kill zone. The housing 34 may be connected to the housing of generation module 20 by any suitable means to achieve a watertight seal. As the fluid passes into the kill zone between the anode 36 and cathodes 38, it may be exposed to a high voltage electrostatic field that is focused by the Halbach magnetic array 40 in a fashion that kills both bacteria and viruses. This results in a fluid that is free of organic contaminants. The anode 36 may be ideally formed of sheet metal and may be provided with apertures 41 during processing of the sheet metal. The sheet metal may then be formed into the desired conical shape and either welded or brazed to join the ends. In this fashion, costs are minimized and the anode is shaped as a hollow cone with apertures in the most cost effective fashion. Other methods of fabrication can be utilized with varying degrees of efficiency and cost effectiveness without departing from the spirit of the present invention.

The cathodes 38 may be formed of a metallic mesh, cut to the desired shape, and then formed into a shape that will receive the anode within close proximity without permitting contact with the anode 36, as shown in FIG. 2. The anode 36 and the cathodes 38 cannot, as any such contact would cause shorting and destroy the electrostatic field. The cathodes 38, being mesh, also include apertures 41 (shown in FIGS. 21 and 22), which permit passage of the fluid therethrough after treatment in the kill zone. The cathodes 38 may be made rigid after forming and provided with suitable outer circumferential surfaces to permit mechanical seating against the interior of the housing 34 to assure a fixed relative location within the device 10.

The housing 34 may be provided with suitable ridges on its inner surface to permit seating of sequential staged filters 42, shown in FIGS. 23 and 24, that can be electrically biased to assist in the removal of charged organic and inorganic particulates after the fluid passes through the kill zone between the anode 36 and cathodes 38. This permits (through optimum selection of filter materials) the removal of desired contaminants from the fluid stream. The filters 42 may be electrically biased to achieve removal of a variety of organic and inorganic contaminants. In one embodiment of the process of the present invention, the filters 42 may be oppositely charged (e.g., first positive and then negative) to attract different types of contaminants.

As shown in greater detail in FIGS. 14, 15, and 16, the filters 42 may be constructed of an outer shell 44 enclosing an inner core 46 with wire mesh discs 48 closing the opposite ends of the filter assembly 42. The filter assembly 42 may be designed to have a snug fit within the housing 34 (shown, e.g., in FIGS. 23 and 24). Activated charcoal and carbon filters have been found to be versatile filters to use. If arsenic is the inorganic contaminant that is the object of the purification process, it has been found desirable to use a pure iron filter as iron removes large quantities of arsenic. In some embodiments, the end of the device may be provided with an outlet cap 50 (shown alone in FIGS. 19 and 20) having an inner circumferential diameter that substantially matches the outer diameter of the housing 34 to provide a watertight seal between the two and an exit passage 52 that allows the purified water or other liquid to exit the device 10. The outlet cap 50 and the housing 34 may be designed to be easily disengaged to permit removal and replacement of the filters 42 when they are saturated with contaminants and no longer effectively usable.

It has been found desirable to be able to manufacture as few different sizes of devices as possible. Such standardization may allow for economies in the manufacturing process not achievable in settings involving customized devices for each application. The size of devices according to embodiments of the present invention may be standardized through the use of a manifold having multiple parallel output pathways for fluid flowing from a single fluid input line. The number of parallel branches to the manifold may be determined by using a ratio of the cross-sectional area of the standard device to the cross-sectional area of the feed line supplying the fluid. The sum of the cross-sectional areas of the outlets from the manifold should equal or exceed the sum of the cross-sectional areas of the inlet (or inlets) to the manifold. This may allow for use of a standardized device 10 according to embodiments of the present invention with fluid feed lines of any theoretical size, adding to the versatility of the device 10 and the methodology that it practices.

The exterior housing and surfaces of embodiments of the present invention may be nonconductive, and the interior may be properly grounded. In this manner, severe injury can be avoided and great benefit enjoyed through use of embodiments of the present invention. While any fluid can be purified using embodiments of the device 10, the inventors contemplate that the primary use will be for the purification of water, which is one of the most precious commodities on our planet as all life depends upon it in order to survive. Under ideal circumstances, nearly any type of impurity can theoretically be removed utilizing a device according to embodiments of the present invention. As a practical matter, proper matching of the filtration systems to the target impurities will need to be tailored for particularly troublesome applications. It is contemplated that embodiments of the present invention may be used by military personnel with an uncertain source of water or residents of underdeveloped countries with a water supply of questionable quality. Embodiments of the present invention will work, even without a separate independent power supply, to purify water as long as a pressurized flow of water is fed into the device.

In some embodiments, the device 10 may include a separate surge tank module 17, an intake housing 12, a power generation module 20, a purification portion supported by a housing 34 (which may include a separately replaceable anode 36, cathodes 38, and filters 42 that can be replaced as needed), a Halbach array 40, and an end cap 52, all of which can be replaced if damaged or fully depleted as in the case of the filters 42, anode 36 and cathodes 38. Additionally, the components of the power generation module 20 (turbine 22, support structures 29, bearings 28, shaft 24, rotor 26, and stator 27) will be understood to have a finite useful life and may be in need of periodic repair or replacement. The modular design of embodiments of the present invention may allow for economies associated with ownership, manufacturing, operation, and repair. Similarly, the transformer 31 and the rectifier 32 may be externally mounted, as shown, and may be easily repaired and replaced when they are faulty or become damaged and are no longer useful. The device is assembled so as to provide a watertight seal between the individual modules or component parts 17, 12, 20, 34, and 52, but at the same time permit easy disassembly for repair.

From this discussion, it should be understood that the device according to embodiments of the present invention may be modularized to extend its useful life and create economies associated with repair of failed individual modules 17, 12, 20, 34, and 52 and component parts. In other words, failure of an individual module or part will require repair or replacement only of that individual module and not replacement of the entire unit 10. This should extend the useful life of the device while minimizing the cost of ownership and long-term use of its unique methodology.

To better understand the operation of the device according to the present invention 10 and the methodology associated with its use, we will now describe the manner of using it.

With reference to FIGS. 1 and 2, a fluid such as water may be ported into the intake 15 and through the intake housing 12. If there is an excessive level of pressure in the fluid flow, the surge suppressor 17 may alleviate the excess pressure to a level that the balance of the device can process and purify without damaging any downstream components. The venturi 14 may maintain the pressure at a sufficiently high pressure to assure proper operation of the balance of the downstream components.

As the water exits the intake housing 12 at a desired level of pressure, it enters the power generation module 20. The water there drives the coaxially mounted turbine 22, shaft 24 and rotor 26 within the space defined by the interior of the stator 27 to create an electric output that is fed to the transformer 31 and rectifier 32. The output of the power generation module 20 and rectifier 32 may then be fed to the anode 36 and cathodes 38 to create a kill zone between them where organic contaminants are destroyed by exposure to a high voltage electrostatic field created by the charged cathodes 38 and anode 36. Both organic and inorganic contaminants may be charged to enable easy removal by filters 42 downstream, as described herein after. The Halbach style magnetic array 40 may focus the electrostatic field for optimization of operation. Additionally, the magnetic array 40 can be used to create its own electromagnetic field within the kill zone between the cathodes 38 and the anode 36 and further adversely impact the lives of organic contaminants and facilitate removal of other inorganic contaminants like calcium carbonate.

As the water exits the power generation module 20 having created a source of power useful in purifying the water, it is fed to the interior of the anode 36 which includes apertures 41 to permit passage of the water through and into the kill zone between the anode 36 and cathodes 38. After the water passes into the kill zone, it then passes through the apertures 41 of the cathode. Passage of the water through the kill zone between the anode 36 and cathodes 38 together with the Halbach array 40 kills organic contaminants and charges inorganic undesirable contaminants such as arsenic and calcium carbonates or any other contaminants in a fashion well known in the useful arts so that they can be trapped and removed once deposited upon the anode 36 or downstream by filters 42 in the present invention as more fully described below, leaving a clean useful water flow that can be utilized without an independent power supply to operate the purification system.

After the water exits the cathodes 38 through apertures 41 thereof, it proceeds downstream in housing 34 into a series of staged filters 42. The filters 42 can be provided with filter cores 46 that are selected from a long list of filtering compounds such as charcoal, carbon, iron (for arsenic removal), or any other suitable substance depending upon the target contaminant as described above. The filters 42 can be electrically biased by using the output of the power generation module 20 or an independent power supply if available to provide an easy and simple means for removing the contaminants from the fluid flow thereby providing a stream of water that is free of undesirable organic and inorganic elements for passage through the exit cap 50 to be further processed or otherwise used or consumed downstream.

As noted above, the power generation module 20 may be an optional component that is utilized only where there is no independent source of power that can be used to bias the anode 36, cathodes 38 and, where appropriate, activated filters 42. Where there is a readily available source of electric power, the entire power generation module 20 can easily and desirably be removed or eliminated from a construction according to embodiments of the present invention, without departing from the methodology of the present invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A device for purifying fluids comprising:
means for providing and receiving a fluid flow under pressure and maintaining a desired pressure level of said fluid;
means for creating an electrical current;
means for converting said electrical current into desired positive and negative electrostatic charges spaced relative to each other so as to create an electrostatic field;
means for directing said flowing fluid through said electrostatic field so as to adversely affect both organic and inorganic impurities in the fluid flow;
means for filtering the fluid flow after it has passed through the electrostatic field; and
means for directing said fluid flow from the improved device for purifying fluids.

2. The device of claim 1 further including means for generating an electromagnetic field relative to said electrostatic field so as to focus the electrostatic field and optimize its effect upon the flowing fluid.

3. The device of claim 1, wherein said means for providing a fluid flow under pressure includes a surge suppressor to prevent excessive and undesirable pressure levels of said fluid.

4. The device of claim 1, wherein said means for creating an electrical current generates said current from the flow of fluid through the device of the present invention.

5. The device of claim 1, wherein said means for directing said fluid flow through said electrostatic field includes a spaced anode and cathode operably associated with said means for creating an electrical current.

6. The device of claim 5, wherein each of said anode and cathode is conically shaped and defines apertures to permit the flow of fluid therethrough so as to expose the flowing fluid to said electrostatic field.

7. The device of claim 1 wherein, said means for creating an electrical current comprises a fully submersible turbine and generator means for creating said electrical current from the flow of said fluid to be purified through the device.

8. The device of claim 2, wherein the means for generating an electromagnetic field comprises a Halbach magnet array that surrounds at least a portion of the electrostatic field.

9. The device of claim 1, wherein the means for filtering the fluid comprises an electrically biased filter to attract electrically biased impurities within the flowing fluid.

10. A modular device for purifying fluids comprising at least one of an organic contaminant or an inorganic contaminant, the modular device comprising:
means for receiving a fluid flow and maintaining said fluid at a given pressure level;
a source of electric current;
an anode means operably associated with said electric current for creating a positively charged first location;
a cathode means operably associated with said source of electric power for creating a negatively charged location spaced from said first location to create an electrostatic field between said first and second locations;
means for directing said fluid to be purified between said first and second locations and through said electrostatic field to adversely impact the viability of an organic contaminant carried by said fluid, to charge both organic and inorganic contaminants carried by said fluid, and to cause at least some of the organic and inorganic contaminants to be deposited upon the anode or cathode means of said device;
means for filtering said fluid flow after it passes through said electrostatic field to remove at least of some of said contaminants downstream of said second location; and
means for passing said fluid to the exterior of the device after the fluid has passed through said means for filtering.

11. The device of claim 10, wherein said source of an electric current comprises:
at least one turbine-generator module means located at a location between said means for receiving a fluid flow and said anode means for creating an electric current from the flow of said fluid to be purified.

12. The device of claim 10, wherein said first and second locations are operably associated with a means for creating an electromagnetic field for creating an electromagnetic flux that optimizes the electrostatic field to optimize the adverse impact of said electrostatic field upon contaminants carried by said fluid to be purified.

13. The device of claim 12, wherein said means for creating an electromagnetic field comprises a Halbach type magnetic array.

14. The device of claim 10, wherein said means for filtering electrically biased filters operably associated with said source of electric current to enhance attraction to and containment of contaminants within said biased filters.

15. The device of claim 10, wherein each of said means for receiving a fluid flow, source of an electric current, anode and cathode means, means for directing fluid flow, means for filtering, and means for passing said fluid flow to the exterior of the device is contained in a separate module.

16. A method for purifying a fluid comprising:
providing a flowing fluid;
maintaining said fluid at a predefined fluid pressure;
providing an electrical current;
providing a means for converting said electrical current into positive and negative spaced electrostatic charges so as to create an electrostatic field;
providing an electromagnetic field relative to said electrostatic field so as to optimize the effects of the electrostatic field upon the fluid flow;
passing said flowing fluid through said electrostatic field so as to adversely affect both organic and inorganic impurities contained in said fluid; and
filtering said flowing fluid after it passes through said electrostatic field.

17. A device for purifying fluids comprising:
an intake housing in fluid communication with an inlet, wherein the inlet is configured to allow a fluid stream to enter the intake housing;
a fluid treatment housing in fluid communication with the intake housing, wherein the fluid treatment housing is configured to house an anode and at least one cathode;
a magnetic array surrounding at least a portion of the fluid treatment housing; and
at least one filter in fluid communication with the fluid treatment housing and disposed downstream of the at least one cathode,
wherein the anode and the at least one cathode are configured to create a high voltage electrostatic field therebetween,
wherein the magnetic array is configured to focus the electrostatic field on a predefined region within the fluid treatment housing, such that a kill zone is established within the fluid treatment housing that is configured to kill at least some organic contaminants carried by the fluid passing therethrough, and
wherein the at least one filter is configured to remove at least some organic or inorganic contaminants from the fluid passing therethrough.

18. The device of claim 17, wherein the magnetic array is a Halbach array.

19. The device of claim 17, wherein the at least one of the anode or the at least one cathode is configured to allow fluid to pass therethrough.

20. The device of claim 17, wherein the at least one filter comprises two filters, and wherein the two filters are oppositely charged with respect to each other.

21. The device of claim 17 further comprising a power generation module in fluid communication with the intake housing and the fluid treatment housing and disposed therebetween, wherein the power generation module is configured to generate electricity as a result of the fluid passing therethrough.

22. The device of claim 21, wherein the power generation module is configured to pass the electricity to at least one of the anode and the at least one cathode or the at least one filter.

23. The device of claim 17 further comprising a surge suppressor tank in fluid communication with the intake housing, wherein the surge suppressor tank is configured to reduce excess pressure of the fluid passing through the fluid intake housing.

24. The device of claim 17 further comprising a venturi disposed upstream of the intake housing, wherein the venturi is configured to increase a pressure of the fluid passing therethrough.

25. A method of purifying fluids comprising:
introducing a flow of fluid from a fluid source;
maintaining the fluid at a predefined pressure;
passing the fluid through an electrostatic field, wherein the electrostatic field is focused on a predefined region through which the fluid is passed via an electromagnetic field; and
filtering the fluid after the fluid has been passed through the electrostatic field,
wherein the electrostatic field defines a kill zone that is configured to kill at least some organic contaminants carried by the fluid passing therethrough, and
wherein filtering the fluid comprises removing at least some organic or inorganic contaminants from the fluid passing therethrough.

26. The method of claim 25 further comprising increasing a pressure of the fluid introduced to the predefined pressure.

27. The method of claim 25 further comprising using the flow of fluid to generate electricity.

28. The method of claim 27, wherein the electricity generated is used to create the electrostatic field.

29. The method of claim 25, wherein filtering the fluid comprises attracting negatively charged contaminants to a first filter and attracting positively charged contaminants to a second filter.

30. A system for processing a fluid flow from a fluid main utilizing devices of the type claimed in claim 1 which includes: a manifold having at least one inlet and at least one outlet, wherein the inlet portion of the manifold receives a fluid flow from a water main of a first size that is operably associated through the manifold with the outlet portion of the manifold with one or more devices of claim 1 in which the sum of the cross-sectional area of all of the manifold outlets is greater than or equal to the cross-sectional area of the manifold inlet.
